(19) United States
(12) Patent Application Publication
(10) Pub. No.: US 2008/0255303 A1
(43) Pub. Date: Oct. 16, 2008

(54) Blends of polyolefins, polar ethylene copolymers and functionalized ethylene copolymers

(76) Inventor: Richard T. Chou, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/786,859

(22) Filed: Apr. 13, 2007

(51) Int. Cl. C08L 53/00

(52) U.S. Cl. 525/89

(57) ABSTRACT

Polymer compositions having excellent physical properties, adhesion to metals and high temperature resistance consist essentially of 1) a polyolefin such as polypropylene, 2) a first ethylene copolymer selected from the group consisting of ethylene/vinyl acetate copolymers, ethylene/alkyl acrylate copolymers, and ethylene/alkyl methacrylate copolymers and 3) a second ethylene copolymer comprising copolymerized units of a) ethylene and b) a monomer selected from the group consisting of i) cyclic anhydrides of C4-C8 unsaturated acids, ii) C4-C8 unsaturated acids having at least two carboxylic acid groups, and iii) mono- and diesters of C4-C8 unsaturated acids having at least two carboxylic acid groups.

### FIELD OF THE INVENTION

This invention relates to blends of polyolefins with polar ethylene copolymers and functionalized ethylene copolymers.

### BACKGROUND OF THE INVENTION

Polypropylene (PP) is used in a wide variety of articles because of its high mechanical strength and high melting point. To enhance its properties polypropylene is often modified with softer polyolefins such as ethylene vinyl acetate (EVA) copolymers, ethylene alkyl acrylate copolymers and ethylene propylene rubber (EPR). These modified polypropylenes exhibit improved properties, such as increased impact resistance and stress cracking resistance. Also, PP may be blended into soft polyolefins as a minor component to enhance the temperature resistance of these softer polymers. For example, International Patent Publication WO 98/47956 discloses halogen-free thermoplastic blends of a polar rubber, ethylene vinyl acetate and a polyolefin, including polypropylene, which blends are flexible and are particularly useful as a replacement for polyvinyl chloride for production of various products.

The lack of functionality in polypropylene and the above-described modified polypropylenes makes paintabilty, adhesion to other substrates, and compatibility with fillers difficult to achieve. One approach to introducing functionality into polypropylene compositions is by modifying polypropylene with anhydride-containing copolymers, such as maleic anhydride-grafted EVA, EPR, or PP. For example, U.S. Pat. No. 5,783,630 discloses a blend of polypropylene with a functionalized polypropylene (maleic anhydride modified PP) and polyether amine in which the polyether amine is grafted onto the functionalized polypropylene. The blend may include an elastomer and/or filler. The blends are useful in preparing paintable automotive body parts.

Anhydride-grafted polymers are obtained by known techniques. For example, an ethylene copolymer such as an ethylene/vinyl acetate copolymer or an ethylene/alkyl acrylate copolymer may be dissolved in an organic solvent along with an unsaturated dicarboxylic acid anhydride, such as maleic anhydride, and a radical generator, followed by heating with stirring. Alternatively, the grafted polymers may be prepared by a process in which the reactive components and the polymer are fed to an extruder, for example to provide a maleic anhydride-grafted ethylene copolymer.

It can be difficult to obtain high levels of grafting using such processes. In order to achieve high levels of grafting it is often necessary to use substantial concentrations of free radical initiator, which can cause undesirable side reactions, such as crosslinking and chain scission. For this reason, production of maleic anhydride-grafted polymers where the level of maleic anhydride incorporated into the polymer is greater than two weight % can be difficult and troublesome. In addition, controlling the quality and consistency of the grafting reaction can be problematic. The presence of by-products and unreacted monomers as well as crosslinked polymer can significantly detract from the quality of maleated ethylene copolymers at any grafting level, but these process issues can become more severe as the grafting level increases. Further, the cost of producing maleated polymers with high maleic graft levels can be substantial. Thus, there are disadvantages associated with manufacture of blends of polypropylene and maleic an hydride-grafted polymers.

Copolymers of ethylene and maleic anhydride that have relatively high levels of copolymerized maleic anhydride are known. Blends of these copolymers with polyolefins or polyamides are useful as impact modifiers and in other applications. For example, International Patent Publication WO2003/09930 discloses a toughened polyamide composition comprising: (1) from about 50 to about 98 weight % of a polyamide polymer resin; and (2) from about 2 to about 50 weight % of an impact modifier composition comprising (a) from about 10 weight % to about 50 weight % of a copolymer prepared from ethylene and a functional comonomer, wherein the copolymer comprises from about 3 weight % to about 15 weight % of the functional comonomer, and (b) from about 50 to about 90 weight % of another polymer that contains copolymerized ethylene units. In one embodiment the functional comonomer is maleic anhydride or its functional equivalent. Also, U.S. Pat. Nos. 6,437,046 and 6,903,161 disclose a blend comprising linear low density polyethylene and copolymer resins, wherein the copolymer comprises from about 0.1 to about 4 weight % acid and from about 0 to about 20 weight % other ethylenically unsaturated comonomer. In addition, U.S. Patent Application Publication 2006/0148988 discloses a composition comprising: (a) a copolymer obtained from copolymerization of ethylene and maleic anhydride or its functional equivalent, in an amount from about 5 to about 95 weight % of the composition; and (b) at least one ethylene copolymer obtained from copolymerization of ethylene with a polar comonomer wherein the polar comonomer is present in the copolymer in an amount of from 6 to 40 weight % and the copolymer is selected from the group consisting of ethylene/vinyl acetate copolymers, ethylene/alkyl(meth)acrylate copolymers and ethylene/(meth)acrylate/carbon monoxide terpolymers, in an amount from about 5 to about 95 weight % of the composition. U.S. Patent Application Publication 2006/0160952 discloses a similar composition that may optionally contain a polyolefin component at a level of up to 25 weight percent of the total composition. Such materials are suitable for use in high-frequency welding processes. Blends of ethylene/maleic acid monoester copolymers and ethylene/vinyl acetate or ethylene/(meth)acrylate copolymers as disclosed in U.S. Patent Application Publication 2006/0025527 are useful in a variety of applications where flexible functional polymer compositions are desirable. However, these blends have a useful temperature range only up to about 90-100° C. There are many applications, however, where flexible polymers with even higher temperature resistance are desirable. For example, resistance at 110-150° C. may be required for sterilization, hot fill applications and sealants.

It would be useful to have available polyolefin blends, especially polypropylene blends, that exhibit good impact resistance, paintability, adhesion to other substrates and high temperature resistance.

### SUMMARY OF THE INVENTION

The present invention relates to a polymer composition consisting essentially of
(a) from about 28 to about 90 weight % of a polyolefin, based on the weight of the polymer composition;
(b) from about 5 to about 60 weight % of a first ethylene copolymer, based on the weight of the polymer composition, where said first ethylene copolymer is selected from the group consisting of ethylene/vinyl acetate copolymers, ethylene/alkyl acrylate copolymers, ethylene/alkyl methacrylate copolymers, and mixtures thereof; and
(c) from about 5 to about 30 weight %, based on the weight of the polymer composition, of a second ethylene copolymer, compositionally different from the first ethylene copolymer, comprising copolymerized units of ethylene and a polar comonomer selected from the group consisting of cyclic anhydrides of C4-C8 unsaturated acids, C4-C8 unsaturated acids having at least two carboxylic acid groups, monoesters of C4-C8 unsaturated acids having at least two carboxylic acid groups, diesters of C4-C8 unsaturated acids having at least two carboxylic acid groups, and mixtures thereof, wherein said second ethylene copolymer comprises from about 5 to about 15 weight % copolymerized units of said polar comonomer, based on the weight of the second copolymer.

The invention also relates to articles comprising the polymer composition. Preferably the articles comprise polypropylene as the polyolefin component of the polymer composition. The polypropylene-containing articles are resistant to high temperatures and may be sterilized at temperatures in the range of about 110° C. to about 150° C.

### DETAILED DESCRIPTION OF THE INVENTION

Trademarks are shown in upper case. Unless stated otherwise, all percentages, parts and ratios are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range having a lower limit of 0, such component is an optional component. Such optional components, when present, are included in a finite amount preferably, of at least about 0.1 weight % of the total weight of the composition. The term “finite amount” refers to an amount that is greater than zero.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like. In general, an amount, size, formulation, parameter or other quantity or characteristic is “about” or “approximate” whether or not expressly stated to be such. When the term “about” is used in describing a value or an end-point of a range, the disclosure should be understood to include the specific recited value or end-point.

The term “consisting essentially of” when used herein in reference to a composition means that the composition is limited to the specified materials and those that do not materially affect the basic and novel characteristics of the composition.

The compositions of the invention consist essentially of at least three distinct polymeric components. These components are a polyolefin, a first ethylene copolymer and a second ethylene copolymer. The first ethylene copolymer comprises copolymerized units of ethylene and an ester comonomer. The first ethylene copolymer is selected from the group consisting of ethylene/vinyl acetate copolymers, ethylene/alkyl acrylate copolymers and ethylene/alkyl methacrylate copolymers. The first ethylene copolymer may also be a mixture of two or more of these ethylene copolymer species. The second ethylene copolymer comprises copolymerized units of ethylene and a polar comonomer selected from the group consisting of cyclic anhydrides of C4-C8 unsaturated acids, C4-C8 unsaturated acids having at least two carboxylic acid groups, monoesters of C4-C8 unsaturated acids having at least two carboxylic acid groups and diesters of C4-C8 unsaturated acids having at least two carboxylic acid groups. The second ethylene copolymer may also be a mixture of two or more of these ethylene copolymer species. The copolymerized units result from copolymerization of the monomers, generally free radical-initiated random copolymerization. Thus, the copolymer backbone is formed of copolymerized monomer units of ethylene and the polar comonomer.

Preferably, two-component blends of the first and second ethylene copolymers that are useful in forming the polymer compositions of the invention are miscible. The definitions for the terms “miscible”, “miscibility” and “miscible blend” as used herein are to be construed as described in Olabisi Olagoki, Lloyd M. Robeson and Montgomery T. Shaw, Polymer-Polymer Miscibility, New York, Academic Press, 1979. As a general definition, a miscible blend of a two-component system forms a homogeneous system that is a single phase. That is, the first polymeric component has some degree of solubility in the second polymeric component. The term miscibility does not imply ideal molecular mixing but suggests that the level of molecular mixing is adequate to yield macroscopic properties expected of a single phase material. In contrast, an immiscible blend of a two-component system remains a two-phase system, and the two-phase nature can often be revealed using optical microcopy or electron microscopy.

Although three-component polymer compositions of the invention that contain the above-described first and second ethylene copolymers and polyolefins such as polypropylene are not miscible, they are highly compatible. The term “compatible” as used herein refers to blends of different polymers that can be well dispersed in each other without significant phase separation. As such, “compatible” does not imply that the polymers form miscible blends as defined above. The three component polymer blends of the invention are suitable for preparing materials with improved performance in comparison to prior art two-component blends. In particular, temperature resistance is improved for the three-component polymer compositions of the invention with from about 28 to about 50 weight % polyolefin. Improvement of surface properties such as adhesion to metals and other substrates, improvement of compatibility with fillers and glass fibers, and attainment of surface paintability is obtained for the three-component polymer compositions of the invention with from about 50 to about 90 weight % polyolefin.

The first component of the polymer compositions of the invention is a polyolefin. Generally, the polyolefin will be present in an amount from about 28 weight %, preferably about 30 weight %, to about 90 weight %, based on the total weight of the polymer composition. Examples of polyolefins that may be used are polypropylene homopolymers, copolymers of propylene with alpha-olefins such as C4-C10 alpha-olefins, polyethylene homopolymers and copolymers of ethylene and alpha-olefins, including copolymers with propylene and other alpha-olefins. Polyethylenes and ethylene copolymers suitable for use as components include high density polyethylenes, low density polyethylenes, linear low density polyethylenes, and copolymers of ethylene and alpha-olefin monomers prepared in the presence of metallocene catalysts, single site catalysts or constrained geometry catalysts (hereinafter referred to as metallocene polyethylenes, or MPE), where the melting point of the polyolefin is higher than 100° C., preferably higher than 110° C. Preferably, the polyolefin is selected from the group consisting of polypropylene homopolymers and copolymers, high density polyethylenes, and low density polyethylenes. More preferably, the polyolefin is selected from the group consisting of polypropylene homopolymers and copolymers and high density polyethylenes. Most preferably the polyolefin is a polypropylene homopolymer.

Polyethylene homopolymers and copolymers can be prepared by a variety of methods. Examples of such processes include, but are not limited to, the well-known Ziegler-Natta catalyst polymerization process (see for example U.S. Pat. No. 4,076,698 and U.S. Pat. No. 3,645,992), metallocene catalyzed polymerization, VERSIPOL single-site catalyst polymerization and free radical polymerization. As used herein, the term metallocene catalyzed polymerization includes polymerization processes that involve the use of metallocene catalysts as well as those processes that involve use of constrained geometry and single-site catalysts. Polymerization can be conducted as a solution-phase process, a gas phase-process and the like.

Without being held to any particular theory, MPE is of note because of its substantially linear structure and narrow molecular weight distribution. Metallocene technology is capable of making lower density polyethylene having high flexibility and low crystallinity. Metallocene technology is described in, for example, U.S. Pat. Nos. 5,272,236; 5,278,272; 5,507,475; 5,264,405 and 5,240,894.

Examples of linear polyethylenes include ethylene copolymers having copolymerized units of alpha-olefin comonomers such as butene, hexene or octene to provide preferred copolymers having a melting point higher than 100° C. For example, a copolymer useful as the polyolefin component can comprise a major portion or percentage by weight of copolymerized units of ethylene and a minor portion or percentage by weight of copolymerized units of at least one other alpha-olefin. Suitable alpha-olefins can be selected from the group consisting of alpha-olefins having at least three carbon atoms, preferably from 3 to 20 carbon atoms. These comonomers are present as copolymerized units in an amount of up to about 20 weight % of the copolymer. Preferred alpha-olefins include propylene, 1-butene, 1-hexene, 4-methyl-1-pentene, 1-octene, 1-decene, 1-tetradecene and 1-octadecene. Copolymers can be obtained by polymerization of ethylene with two or more alpha-olefins, preferably including propylene, 1-butene, 1-octene and 4-methyl-1-pentene.

Also contemplated for use as the polyolefin component are blends of two or more of these ethylene alpha-olefin copolymers as well as mixtures of an ethylene homopolymer and one of the suitable ethylene alpha-olefin copolymers.

Polypropylene polymers suitable for use as the polyolefin component of the polymer compositions of the invention include homopolymers, random copolymers, block copolymers and higher order copolymers, such as terpolymers of propylene. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene. Copolymers of propylene include copolymers of propylene with other olefins such as 1-butene, 2-butene and the various pentene isomers, etc. and preferably copolymers of propylene with ethylene, wherein units derived from propylene comprise the major portion or percentage by weight of the copolymer. By major portion or percentage is meant about 50% or more, preferably 70% or more.

Polypropylene homopolymers or random copolymers can be manufactured by any known process. For example, polypropylene polymers can be prepared in the presence of Ziegler-Natta catalyst systems, based on organometallic compounds and on solids containing titanium trichloride.

Block copolymers can be manufactured similarly, except that propylene is generally initially polymerized by itself in a first stage and propylene and additional comonomers such as ethylene are then polymerized, in a second stage, in the presence of the polymer obtained during the first stage. Each of these stages can be carried out, for example, in suspension in a hydrocarbon diluent, in suspension in liquid propylene, or in gaseous phase, continuously or discontinuously, in the same reactor or in separate reactors.

When used herein, “polypropylene” refers to any of the polypropylene homopolymers and propylene copolymers described above.

The polymer compositions of the invention comprise from about 5 to about 60 weight % of a first ethylene copolymer selected from the group consisting of ethylene/vinyl acetate copolymers, ethylene/alkyl acrylate copolymers and ethylene/alkyl methacrylate copolymers, and mixtures thereof.

In one aspect the first ethylene copolymer may be an ethylene/vinyl acetate copolymer, that is, a copolymer of monomers comprising ethylene and vinyl acetate. Ethylene/vinyl acetate (EVA) copolymers are inclusive of EVA dipolymers, EVA terpolymers and higher order copolymers. The term “EVA dipolymers” describes copolymers consisting of only copolymerized units of ethylene and vinyl acetate. The term “EVA terpolymers” describes copolymers prepared by copolymerization of ethylene, vinyl acetate and an additional comonomer. Preferred examples of vinyl acetate copolymers are those wherein the weight percentage of copolymerized vinyl acetate units is from about 9 to about 35 weight % of the EVA copolymer. Copolymers having about 12 to about 30 weight % copolymerized vinyl acetate units are more preferred.

Ethylene/vinyl acetate copolymers include those available from E. I. du Pont de Nemours and Company (DuPont), Wilmington, Del. under the ELVAX tradename.

A mixture of two or more different ethylene/vinyl acetate copolymers may be used as the first ethylene copolymer component in the compositions of the invention in place of a single copolymer so long as the average values for the comonomer content will be within the range indicated above. Particularly useful properties may be obtained when two or more properly selected ethylene/vinyl acetate copolymers are used.

The first ethylene copolymer may also be an ethylene alkyl acrylate copolymer or an ethylene alkyl methacrylate copolymer. That is, the copolymer will comprise copolymerized units of ethylene and an alkyl acrylate or an alkyl methacrylate. Such copolymers are preferably those wherein the alkyl group contains from one to six carbon atoms. More preferably, the alkyl group of the alkyl acrylate or alkyl methacrylate comonomer has from one to four carbon atoms. Most preferable acrylate monomers are methyl acrylate, ethyl acrylate, i-butyl acrylate and n-butyl acrylate.

The weight percentage of copolymerized units of alkyl acrylate or alkyl methacrylate comonomer present in the ethylene/alkyl acrylate or ethylene methacrylate copolymer can vary broadly from 2 weight % up to as high as 40 weight % of the copolymer or even higher. Preferably, the weight percentage of copolymerized units of alkyl acrylate comonomer will be from about 9 to about 35 weight %, more preferably from about 12 to about 30 weight %, based on the weight of the ethylene/alkyl acrylate copolymer. Similarly, the weight percentage of copolymerized units of alkyl methacrylate comonomer will preferably be from about 9 to about 35 weight %, more preferably from about 12 to about 30 weight %, based on the weight of the ethylene/alkyl methacrylate copolymer.

Ethylene/alkyl acrylate copolymers include those available from DuPont under the ELVALOY AC tradename.

A mixture of two or more different ethylene/alkyl acrylate or ethylene/alkyl methacrylate copolymers can be used as the first ethylene copolymer in the compositions of the invention in place of a single copolymer so long as the average values for the comonomer content will be within the range indicated above. Particularly useful properties may be obtained when two or more properly selected ethylene/alkyl acrylate or ethylene alkyl/methacrylate copolymers are used in the polymer compositions of the invention.

The polymer compositions of the invention also comprise a second ethylene copolymer, compositionally different from the first ethylene copolymer, that comprises copolymerized units of ethylene and from about 5 to about 15% by weight of a functional comonomer selected from the group consisting of cyclic anhydrides of C4-C8 unsaturated acids, C4-C8 unsaturated acids having at least two carboxylic acid groups, monoesters of C4-C8 unsaturated acids having at least two carboxylic acid groups (e.g. those diacids wherein one carboxyl group is esterified and the other is a carboxylic acid group), diesters of C4-C8 unsaturated acids having at least two carboxylic acid groups, and mixtures thereof. The morphology of the second ethylene copolymer is such that the polymeric chains consist of random copolymerized units of ethylene and about 5 to about 15% by weight of functional comonomer units. Random copolymers are a distinct class and differ from grafted polymers. Grafted polymers contain functional groups present only as pendant moieties that have been grafted onto the main polymer chain. Preferably, the functional comonomer comprises about 6 weight % to about 15 weight % of the random copolymerized units of the copolymer chain.

Examples of useful functional comonomers include maleic acid, maleic anhydride, maleic acid diesters, maleic acid monoesters, itaconic acid, itaconic anhydride, fumaric acid, fumaric acid monoesters, fumaric acid diesters, citraconic acid, citraconic acid diesters, citraconic acid monoesters and mixtures thereof. Maleic acid monoesters are also known as maleic half-esters or alkyl hydrogen maleates.

Copolymers of ethylene and maleic anhydride are preferred. Copolymers of ethylene and maleic acid monoesters, more preferably maleic acid C1-C4 alkyl monoesters such as, for example, methyl, ethyl, n-propyl, isopropyl, and n-butyl monoesters are highly preferred, and copolymers of ethylene and maleic acid monoethyl ester (i.e. ethyl hydrogen maleate) are most preferred.

Other useful examples of the second ethylene copolymer are terpolymers comprising copolymerized units of ethylene; copolymerized units of a first polar comonomer selected from the group consisting of C1-C4 alkyl diesters of maleic acid and C1-C4 alkyl monoesters of maleic acid; and copolymerized units of a second comononer selected from the group consisting of vinyl acetate, C1-C4 alkyl acrylates and C1-C4 alkyl methacrylates. Preferred terpolymers include those having less than 10 weight % copolymerized units of the second comonomer, based on the weight of the terpolymer. Preferably, less than 5 weight % copolymerized units of the second comonomer will be present, based on the weight of the terpolymer.

Maleic anhydride, maleic acid diesters and maleic acid monoesters, preferably esters of C1 to C4 alcohols, such as, for example, methyl, ethyl, n-propyl, isopropyl, and n-butyl alcohols, are useful as the first comonomer in the above-described ethylene terpolymers. Maleic anhydride, maleic acid diesters, and maleic acid monoesters are highly preferred. Maleic acid monoesters are most preferred.

Preferred monomers suitable for use as the second comonomer in the above-described terpolymer are acrylic acid esters and methacrylic acid esters of C1 to C4 alcohols. Methyl acrylate and butyl acrylate are particularly preferred examples of the second comonomer.

For example, the second ethylene copolymer may be a terpolymer prepared by direct copolymerization of monomers comprising copolymerized units of ethylene; copolymerized units of maleic acid C1 to C4 alkyl diesters or monoesters; and copolymerized units of monomers selected from the group consisting of vinyl acetate, C1-C4 alkyl acrylates and C1-C4 alkyl methacrylates.

The second ethylene copolymers useful as components of the polymer compositions of the invention are obtained by a process of high-pressure free radical polymerization. They are “direct” copolymers, that is, copolymers polymerized by adding all monomers simultaneously. A high-pressure process suitable for preparing such copolymers is described, for example, in U.S. Pat. No. 4,351,931. This process provides random copolymers having copolymerized units of monomers that react with each other to form the polymer chain. The units are thus incorporated into the polymer backbone or chain. These direct copolymers are distinct from graft copolymers, wherein a monomer is grafted onto an existing polymer to form a polymer chain having pendant groups, often by a subsequent free radical reaction process.

Conventional additives used in polymeric materials may additionally be present in the polymer compositions of the invention so long as they do not materially affect the basic and novel characteristics of the composition. Such additives include plasticizers, impact modifiers, stabilizers such as viscosity stabilizers and hydrolytic stabilizers, antioxidants, ultraviolet ray absorbers, antistatic agents, dyes, pigments or other coloring agents, inorganic fillers, fire-retardants, lubricants, reinforcing agents such as glass fiber and flakes, foaming or blowing agents, processing aids, antiblock agents, release agents, and mixtures thereof. The amount of optional additives, when used, can vary over a wide range. They will generally be present in quantities of up to 20 weight percent of the polymer composition. The amount is not critical. Suitable amounts will be dependent upon the particular application, article or process in which the compositions are utilized.

The polymer compositions of the invention may be prepared by conventional polymer blending techniques well known to those skilled in the art, e.g. by compounding in a polymer extruder or by melt blending. All of the components may be simultaneously blended or the polyolefin may be blended with a pre-blended mixture of the polar and functional ethylene copolymers.

The components of the polymer composition of the invention may be present in certain preferred ratios. For example, the weight ratio of the first ethylene copolymer to the second ethylene copolymer may be from about 10:1 to about 1:5, or from about 5:1 to about 1:1, or from about 3:1 to 2:1.

In a preferred embodiment, the polyolefin, preferably polypropylene, is present in an amount of from about 50 to about 90 weight % of the total polymer composition.

When the polyolefin comprises about 50 to about 90 weight % of the polymer composition, the first ethylene copolymer may be present in amounts of about 5 weight %, preferably about 10 weight %, to about 45 weight %, and the second ethylene copolymer may be present in amounts of about 5 weight % to about 45 weight %, preferably about 40 weight %, the percentages being based on the total weight of the polymer composition. Exemplary compositions include those wherein the polyolefin, such as polypropylene, is present in an amount of about 60 weight %, the first ethylene copolymer is present in an amount of about 30 weight % and the second ethylene copolymer is present in an amount of about 10 weight %, the percentages being based on the total weight of the polymer composition.

When polypropylene is the major component, e.g. from about 50 to about 90 weight % of the polymer composition, and the first and second ethylene copolymers make up the minor component of the composition, the combination of ethylene copolymers is found to impart desirable physical properties to the polypropylene compared to polypropylene itself.

The property enhancement includes improvement of surface properties such as adhesion to metals and other substrates, improvement of compatibility with fillers and glass fibers, and attainment of surface paintability. These enhanced physical properties are obtained while retaining the high melting point and high mechanical strength characteristic of unblended polypropylene. Similar property improvements are exhibited by the polymer compositions of the invention that contain other polyolefins described herein.

In one aspect, polymer compositions of the invention wherein polypropylene is a major component and ethylene/maleic acid monoester copolymer is the second ethylene copolymer component exhibit improved toughness and solvent stress cracking properties, better adhesion to paint and adhesives, and better compatibility with fillers and glass fibers compared to polypropylene itself.

It has also been found that when a copolymer of ethylene and maleic acid monoester is used as the second ethylene copolymer component in the polypropylene-containing polymer compositions of the invention films made from the composition exhibit an increase in clarity and a reduction in haze compared to films made from polypropylene compositions that contain only a species of the first ethylene copolymer.

In another preferred embodiment, the polyolefin, preferably polypropylene, is present in an amount of from about 28 to about 50 weight % of the polymer composition. Such compositions exhibit improved temperature resistance and higher modulus compared to blends of the first and second ethylene copolymers that do not contain polyolefin.

When the polyolefin, for example polypropylene, comprises about 28 to 50 weight % of the polymer compositions of the invention, the first ethylene copolymer may be present in an amount of about 20 to about 60 weight %, based on the total weight of the polymer composition and the second ethylene copolymer may be present in an amount of about 10 to about 30 weight %, based on the total weight of the polymer composition. Compositions wherein the first ethylene copolymer is present in an amount of about 30 weight % to about 50 weight %, and the second ethylene copolymer is present in an amount of about 15 weight % to about 25 weight % (the percentages being based on the total weight of the polymer composition), may be preferred in certain instances.

Two-component polymer compositions comprising the first and second ethylene copolymers where no polypropylene is present have an upper usage temperature of only about 90° C. Many articles and applications require higher temperature resistance. For example, applications that involve retort sterilization, i.e., in manufacture of aseptic packages, require a temperature resistance up to about 120° C.-150° C. The presence of minor amounts of polypropylene in blends of the ethylene copolymers imparts a higher usage temperature and enhanced mechanical strength. Polymer compositions of the invention comprising from about 28 to about 50 weight % polypropylene, based on the weight of the total composition, have an upper temperature resistance higher than that of a composition that is a blend of the first and second ethylene copolymers components. In addition such compositions retain the flexibility associated with the miscible blends of the first and second ethylene copolymers.

Articles of the invention are those that comprise the polymer composition in any aspect. For example, articles may be films, sheets, laminated films or sheets, containers such as pouches, bags, bottles, jars, tubs, tanks, trays, cups and other shaped articles, including tubing and molded parts for automotive or other vehicles, and manufactured goods.

Specific examples of articles of the invention exhibiting improved properties compared to similar articles formed of unblended polypropylene are articles formed of filled and glass-reinforced polymer compositions of the invention. Such articles include containers, polypropylene/metal composite films, and articles where paintability of the composition is required.

The following Examples are presented to more fully demonstrate and further illustrate various aspects and features of the present invention. The materials, methods, and examples herein are illustrative only and, except as specifically stated, are not intended to be limiting embodiments.

### EXAMPLES

### Test Methods

As used in the examples below, melt index (MI) refers to melt index as determined according to ASTM D1238 at 190° C. using a 2160 g weight, with values of MI reported in g/10 minutes.

Tensile strength, elongation at break and tensile strength at 100% elongation were measured according to ASTM D882.

Graves tear strength was measured according to ASTM D1004.

Shore A Hardness was measured according to ASTM D2240.

Temperature resistance was determined in an oven creep test according to the following procedure. A 20-gram weight was attached to a film sample having a thickness of 10 mils, a length of 6 inches and a width of 1 inch. The 10 mil films were prepared on a slot die cast film line as described below. The test sample was suspended with the weight at the bottom in an oven and heat aged with the temperature varied from 100° C. to 150° C. in ten degree increments. The temperature at which the film was deformed with breaks or with more than 10% of elongation is reported in Table 1 below as the Upper Temperature Resistance.

The adhesion strength to aluminum foil was determined according to the following procedure. Three-layer composites were assembled by stacking in order: Aluminum foil/cast film/aluminum foil. The aluminum foil was 5 mil thick. The stacked layers were preheated in a lamination press set at 180° C. for 5 minutes and then pressed for 60 seconds at 44 psi (3.1 kg/cm²) pressure to form the laminated composite structure. After the structure was cooled to room temperature, 1-inch wide strips were cut from the 3-layer composites. The peel strength strips were tested for adhesion characteristics in an INSTRON (90 degree peel test; at a speed of 50 mm/minute).

The adhesion strength to nylon 6 (ULTRAMID B3 from BASF) was determined according to the following procedure. Nylon 6 films of 10 mil thickness were prepared by press-molding at 250° C. Two-layer composites of nylon 6 film and the cast films of Table 2 were assembled by stacking the films together. The stacked layers were then pressed for 30 seconds at 44 psi (3.1 kg/cm²) pressure in a lamination press set at 240° C. to form the laminated composite structure. After the structure was cooled to room temperature, the two layer laminates were peeled apart by hand to assess seal strength.

A Radio Frequency (RF) welding study was conducted using a SOLIDYNE INDUSTRIAL RF GENERATOR (Solidyne Corporation) having a maximum output of 10 kW and operating at 27 MHz. Two separate plastic film sheets were placed between two electrodes. The electrodes were pressed together with compressed air at 60 psi (4.2 kg/cm²) on a 2-inch (5 cm) diameter ram. The electric field strength was adjusted from 2.0 kV to 9.5 kV by increasing or decreasing the voltage across the electrodes. For example, RF energy was applied to the film samples at 4.0 kV for 3 seconds and then the welded sample was held together under pressure for 2 seconds, allowing the melted polymer to set. The two layers of the RF sealed films were peeled apart by hand to assess seal strength and rated as follows:
Excellent: indicates the two films cannot be separated without rupture of the seal.
Good: indicates the two films can be separated with effort.
Poor: indicates the two films can be separated with ease.
No: indicates the two films did not seal under the RF treatment conditions.

### Materials

EVA-1: Ethylene/vinyl acetate copolymer (25 weight % vinyl acetate), M12 g/10 minutes.
EVA-2: Ethylene/vinyl acetate copolymer (28 weight % vinyl acetate), M13 g/10 minutes.
F-1: Polyethylene/ethyl maleic acid monoester copolymer (90.5 weight % ethylene and 9.5 weight % ethyl hydrogen maleate), M130 g/10 minutes.
EMA: Ethylene/methyl acrylate copolymer (24 weight % methyl acrylate), M12 g/10 minutes.
PP: Polypropylene homopolymer, M13.4 g/10 minutes, density of 0.90 g/cc.

### Examples 1-6 and Comparative Examples C1-C5

Cast films listed in Table 1 and Table 2 and having a thickness of 10 mil (0.25 mm) were prepared using a slot-die cast film line with a 28-mm diameter, 28:1 length to diameter ratio (UD) twin screw extruder. Extrusion was conducted with ramped extruder zone temperatures of 160° C. to 180° C., and a 10-inch (25.4 cm) wide slot die operating at a temperature of 180° C. to cast the melt-processable polymers onto a chilled 20° C. casting roll, forming monolayer films. With the exception of the film in Example 4 of Table 1, the compositions of the cast films were dry blended prior to feeding into the extruder without pre-melt blending. Example 4 is a blend of PP and a pre-melt-blended mixture of EVA-2 and F-1. The pre-melt-blended mixture of EVA-2 and F-1 was prepared by melt blending using a 30-mm diameter twin screw extruder with a mixing screw, using a melt temperature of about 190° C.

Properties of the films obtained in Examples 1-4 and Comparative Example C1 and C2 are presented in Table 1. Properties of the films obtained in Examples 5-6 and Comparative Examples C3-C5 are presented in Table 2.

TABLE 1

| | Example | | | | | |
|---|---|---|---|---|---|---|
| | C1 | C2 | | | | |
| | (Comparative) | (Comparative) | 1 | 2 | 3 | 4 |
| Composition | EVA-1/F-1 | EVA-1/F-1/PP | EVA-1/F-1/PP | EVA-1/F-1/PP | EVA-1/F-1/PP | EVA-2/F-1/PP |
| (Wt. Ratio) | (60/40) | (54/26/20) | (47/23/30) | (40/25/40) | (33/17/50) | (35/15/50) |
| Haze (%) | 8 | 26 | 40 | 54 | 61 | 50 |
| Adhesion to | Not | 590 | 590 | 807 | 586 | 570 |
| Aluminum | measured | | | | | |
| (grams/cm) | | | | | | |
| Tensile | 167 | 190 | 188 | 158 | 186 | 153 |
| Strength | | | | | | |
| (kg/cm²) | | | | | | |
| Graves Tear | 73 | 82 | 88 | 104 | 118 | 102 |
| Strength | | | | | | |
| (kg/cm) | | | | | | |
| Shore A | 89 | 91 | 92 | 93 | 93 | 93 |
| Hardness | | | | | | |
| Upper | 90 | 110 | 120 | 130 | 150 | 150 |
| Temperature | | | | | | |
| Resistance | | | | | | |
| (° C.) | | | | | | |
| RF Welding | Excellent | Excellent | Excellent | Good | Good | Good |

The data in Table 1 demonstrate that the addition of polypropylene at a level of 30 to 50 weight % increased the temperature resistance of the miscible blends of ethylene/maleic acid monoester copolymer and ethylene/vinyl acetate copolymer. Adhesion to aluminum foil, RF welding and good optical clarity characteristics of the copolymer blends are retained compared to C1 and C2 that did not contain PP. As shown in Table 1, upper temperature resistance based on the creep test employed is higher for the compositions of Examples 1-4 compared to C1 and C2.

The compositions of the Examples were readily RF-welded and exhibited high weld strength. The cast films of Examples 1-4 demonstrated good adhesion to metals and had balanced overall mechanical properties as measured by tensile and tear strength. They also exhibited excellent contact clarity as indicated by the % haze measured.

TABLE 2

| | | | | Graves | |
|---|---|---|---|---|---|
| | | Tensile | Tensile | Tear | |
| | Composition | Strength | Elongation | Strength | Adhesion |
| Example | (Wt. Ratio) | (kg/cm²) | (%) | (kg/cm) | to nylon 6 |
| 5 | EVA-1/F-1/PP | 396 | 1100 | 120 | strong |
| | (30/10/60) | | | | adhesion |
| 6 | EMA/F-1/PP | 330 | 1100 | 107 | strong |
| | (30/10/60) | | | | adhesion |
| C3 | EVA-1/PP | 398 | 1070 | 120 | No |
| | (40/60) | | | | Adhesion |
| C4 | EMA/PP | 304 | 1090 | 98 | No |
| | (40/60) | | | | Adhesion |
| C5 | PP | 402 | 900 | 134 | No |
| | | | | | Adhesion |

The data in Table 2 indicate that modification of polypropylene with the miscible blend of EVA or EMA with ethylene/ethyl maleic acid monoester copolymer (Examples 5 and 6) produced compositions with excellent adhesion to nylon 6. The laminates of nylon 6 with Comparative Example C5 (unmodified polypropylene) and Comparative Examples C3 and C4 (blends of polypropylene and EVA or EMA, respectively) were readily peeled apart. The polypropylene modified with the miscible blends of ethylene/maleic acid monoester copolymer and EVA (Example 5) or EMA (Example 6) exhibited excellent mechanical properties and exhibited strong adhesion to nylon 6. The laminates of nylon 6 to Example 5 and Example 6 could not be peeled apart by hand.

What is claimed is:

1. A polymer composition consisting essentially of:
(a) from about 28 to about 90 weight % of a polyolefin, based on the weight of the polymer composition;
(b) from about 5 to about 60 weight % of a first ethylene copolymer, based on the weight of the polymer composition, where said first ethylene copolymer is selected from the group consisting of ethylene/vinyl acetate copolymers, ethylene/alkyl acrylate copolymers, ethylene/alkyl methacrylate copolymers, and mixtures thereof; and
(c) from about 5 to about 30 weight %, based on the weight of the polymer composition, of a second ethylene copolymer, compositionally different from the first ethylene copolymer, comprising copolymerized units of ethylene and a polar comonomer selected from the group consisting of cyclic anhydrides of C4-C8 unsaturated acids, C4-C8 unsaturated acids having at least two carboxylic acid groups, monoesters of C4-C8 unsaturated acids having at least two carboxylic acid groups, diesters of C4-C8 unsaturated acids having at least two carboxylic acid groups, and mixtures thereof, wherein said second ethylene copolymer comprises from about 5 to about 15 weight % copolymerized units of said polar comonomer, based on the weight of the second copolymer.

2. A composition of claim 1 wherein the polyolefin is selected from the group consisting of polypropylene homopolymers, copolymers of propylene and a C4-C8 alpha-olefin, copolymers of ethylene and an alpha-olefin, high density polyethylenes, low density polyethylenes, linear low density polyethylenes, and metallocene polyethylenes, where the melting point of said polyolefin is greater than 100° C.

3. A composition of claim 1 wherein the polyolefin is a polypropylene homopolymer.

4. A composition of claim 1 wherein the first ethylene copolymer is an ethylene/vinyl acetate copolymer.

5. A composition of claim 4 wherein the ethylene/vinyl acetate copolymer comprises from about 9 to about 35 weight % of copolymerized units of vinyl acetate, based on the weight of the ethylene/vinyl acetate copolymer.

6. A composition of claim 1 wherein the first ethylene copolymer is an ethylene/alkyl acrylate copolymer.

7. A composition of claim 6 wherein the ethylene/alkyl acrylate copolymer comprises from about 9 to about 35 weight % of copolymerized alkyl acrylate units, based on the weight of the ethylene/alkyl acrylate copolymer.

8. A composition of claim 7 wherein the alkyl acrylate is selected from the group consisting of methyl acrylate, ethyl acrylate, i-butyl acrylate and n-butyl acrylate.

9. A composition of claim 1 wherein the second ethylene copolymer comprises copolymerized units of ethylene and a monoester of a C4-C8 unsaturated acid having at least two carboxylic acid groups.

10. A composition of claim 9 comprising copolymerized units of a monoester of a C4 unsaturated acid.

11. A composition of claim 10 wherein the monoester is the monoethyl ester of maleic acid.

12. A composition of claim 1 wherein the second ethylene copolymer is a copolymer comprising copolymerized units of
A) ethylene;
B) a first polar comonomer selected from the group consisting of C1-C4 alkyl diesters of maleic acid and C1-C4 alkyl monoesters of maleic acid; and
C) a second comonomer selected from the group consisting of vinyl acetate, C1-C4 alkyl acrylates and C1-C4 alkyl methacrylates.

13. A composition of claim 1 wherein the first ethylene copolymer and the second ethylene copolymer are miscible.

14. A composition of claim 1 wherein the polyolefin is present in an amount of from 50 to about 90 weight % of the polymer composition.

15. A composition of claim 14 wherein the polyolefin is a polypropylene homopolymer.

16. A composition of claim 1 wherein the polyolefin is present in an amount of from about 28 to 50 weight % of the polymer composition.

17. A composition of claim 16 wherein the polyolefin is polypropylene.

18. A composition of claim 17 having an upper temperature resistance higher than that of a blend consisting of the first ethylene copolymer and the second ethylene copolymer present in the composition.

19. An article comprising the polymer composition of claim 1.

20. An article of claim 19 wherein the polyolefin component of the polymer composition is polypropylene.

21. An article of claim 19 wherein the polyolefin component of the polymer composition is present in an amount of from about 50 to about 90 weight % of the polymer composition.

22. An article of claim 19 wherein the polyolefin component of the polymer composition is present in an amount of from about 28 to about 50 weight % of the polymer composition.
